(19) United States
(12) Patent Application Publication
(10) Pub. No.: US 2016/0272152 A1
(43) Pub. Date: Sep. 22, 2016

(54) VEHICLE-MOUNTED WIRELESS COMMUNICATION DEVICE

(71) Applicant: SUMITOMO WIRING SYSTEMS, LTD., Yokkaichi (JP)

(72) Inventor: Takanao IWATA, Yokkaichi (JP)

(73) Assignee: SUMITOMO WIRING SYSTEMS, LTD., Yokkaichi (JP)

(21) Appl. No.: 15/035,519

(22) PCT Filed: Nov. 6, 2014
(86) PCT No.: PCT/JP2014/079393

§ 371 Date: May 10, 2016

(30) Foreign Application Priority Data
Nov. 27, 2013 (JP) 2013-245093

(51) Int. Cl. B60R 25/24; B60R 25/20; G07C 9/00

(52) U.S. Cl. CPC B60R 25/24; G07C 9/00309; B60R 25/209

(57) ABSTRACT

Provided is a wireless communication device configured to be mounted in a vehicle that makes it possible to keep a spare communicator inside the vehicle, while still providing a capability of preventing locking of doors when communicators are determined to still be in the vehicle. A control unit determines whether the main key and the spare key are respectively outside the vehicle and inside the vehicle, according to wireless signals transmitted and received by the wireless communication unit. Also, the vehicle-mounted wireless communication device is provided with a disabling unit that, in the case where a locking instruction reception unit receives a signal relating to a door locking instruction, and it is detected by the control unit that the main key is outside the vehicle and that the spare key is inside the vehicle, disables some functions of the spare key detected as being inside the vehicle.

### TECHNICAL FIELD

Preferred embodiments of the present disclosure relate to a vehicle-mounted wireless communication device for use in a vehicle capable of locking/unlocking doors, starting a prime mover and the like using a portable communicator.

### BACKGROUND ART

Heretofore, systems, known as so-called SMART ENTRY (registered trademark) systems, that automatically lock/unlock vehicle doors in response to touch operations with respect to a specific location of the vehicle by a user who is in possession of a portable communicator are in widespread use. Since doors can be locked/unlocked without the user taking the communicator out of his or her bag or pocket, these systems offer great convenience compared to locking/unlocking doors using a conventional mechanical key. With these systems, it is also possible to start the prime mover of a vehicle without a mechanical key operation, by the user who is in possession of the communicator operating a starter switch arranged in the vicinity of the driver's seat or the like inside the vehicle.

Meanwhile, vehicle door locking systems that prohibit locking with door locking means if the communicator is detected inside the vehicle have been developed, in order to respond to the case where the user forgets the communicator when he or she leaves the vehicle (e.g., see Patent Document 1).

### CITATION LIST

### Patent Documents

Patent Document 1: JP 2010-138543A

### SUMMARY

With vehicles that lock/unlock doors using a communicator, there are calls to further improve convenience by utilizing two communicators, with one of the communicators being put in a bag for carrying around and the other communicator always being kept inside the vehicle in a place where it can be quickly retrieved. Also, there are calls to hide a spare communicator in the vehicle or give a spare communicator to a passenger for safekeeping in preparation for if the communicator is lost. However, with the vehicle door locking system described in Patent Document 1, since the doors are prohibited from being locked if the communicator is detected inside the vehicle, it is not possible to always leave one communicator inside the vehicle or to hide a spare communicator inside the vehicle. Also, in the case of giving a spare communicator to a passenger for safekeeping, the doors cannot be locked unless the passenger gets out of the vehicle.

Preferred embodiments of the present disclosure were made in view of the above situation, and has an object to provide a vehicle-mounted wireless communication device that, in a vehicle provided with a function of locking/unlocking doors and starting a prime mover using a communicator, enables a spare communicator to be placed inside the vehicle while not compromising security.

### Solution to Problem

A vehicle-mounted wireless communication device according to preferred embodiments is a vehicle-mounted wireless communication device including wireless communicating means for transmitting and receiving wireless signals to and from a plurality of portable communicators, detecting means for detecting whether the communicators are outside the vehicle and inside the vehicle, according to the wireless signals transmitted and received by the wireless communicating means, locking instruction receiving means for receiving a signal relating to a door locking instruction, and disabling means for, in a case where the locking instruction receiving means receives the signal relating to the door locking instruction, and the communicators are detected by the detecting means as being outside the vehicle and inside the vehicle, disabling some functions of the communicator detected as being inside the vehicle.

The vehicle-mounted wireless communication device according to preferred embodiments may include start instruction receiving means for receiving a signal relating to a prime mover start instruction, and enabling means for, in a case where the start instruction receiving means receives the signal relating to the prime mover start instruction, enabling the functions of the communicator that were disabled by the disabling means.

The vehicle-mounted wireless communication device according to preferred embodiments may include unlocking instruction receiving means for receiving a signal relating to a door unlocking instruction, and enabling means for, in a case where the unlocking instruction receiving means receives the signal relating to the door unlocking instruction, enabling the functions of the communicator that were disabled by the disabling means.

The vehicle-mounted wireless communication device according to the present invention may include determining means for determining whether a signal received by the locking instruction receiving means is a predetermined signal, and the disabling means may, in a case where it is determined by the determining means that the signal received by the locking instruction receiving means is the predetermined signal, disable some functions of communicator detected as being inside the vehicle.

A vehicle-mounted wireless communication device according to preferred embodiments is a vehicle-mounted wireless communication device including wireless communicating means for transmitting and receiving wireless signals to and from a plurality of portable communicators, detecting means for detecting whether the communicators are outside the vehicle and inside the vehicle, according to the wireless signals transmitted and received by the wireless communicating means, locking instruction receiving means for receiving a signal relating to a door locking instruction, and disabling means for, in a case where the locking instruction receiving means receives the signal relating to the door locking instruction, and the communicators are detected by the detecting means as being outside the vehicle and inside the vehicle, disabling reception of wireless signals from the communicator detected as being inside the vehicle.

The vehicle-mounted wireless communication device according to preferred embodiments may include start instruction receiving means for receiving a signal relating to a prime mover start instruction, and enabling means for, in a case where the start instruction receiving means receives the signal relating to the prime mover start instruction, enabling reception of wireless signals from the communicator that was disabled by the disabling means.

The vehicle-mounted wireless communication device according to preferred embodiments may include unlocking instruction receiving means for receiving a signal relating to a door unlocking instruction, and enabling means for, in a case where the unlocking instruction receiving means receives the signal relating to the door unlocking instruction, enabling reception of wireless signals from the communicator that was disabled by the disabling means.

The vehicle-mounted wireless communication device according to preferred embodiments may include determining means for determining whether a signal received by the locking instruction receiving means is a predetermined signal, and the disabling means may, in a case where it is determined by the determining means that the signal received by the locking instruction receiving means is the predetermined signal, disable reception of wireless signals from the communicator detected as being inside the vehicle.

In some preferred embodiments, the vehicle-mounted wireless communication device, in the case where the locking instruction receiving means receives a signal relating to a door locking instruction, and the communicators are detected by the detecting means as being outside the vehicle and inside the vehicle, disables some functions of the communicator detected as being inside the vehicle. The vehicle thereby does not operate with the disabled communicator.

In some preferred embodiments, the vehicle-mounted wireless communication device, in the case where the locking instruction receiving means receives a signal relating to a door locking instruction and the communicators are detected by the detecting means as being outside the vehicle and inside the vehicle, disables reception of signals from the communicator detected as being inside the vehicle. The vehicle thereby does not operate with the disabled communicator.

In some preferred embodiments, the vehicle-mounted wireless communication device, in the case where an operation relating to starting the prime mover is accepted, enables the functions of the communicator that were disabled or reception of signals from the communicator that was disabled. The disabled functions are thereby restored when starting the prime mover, and the communicator that was disabled is able to operate in a normal state.

In some preferred embodiments, the vehicle-mounted wireless communication device, in the case where an operation relating to unlocking doors is accepted, enables the functions of the communicator that were disabled or reception of signals from the communicator that was disabled. The disabled functions are thereby restored when unlocking the doors, and the communicator that was disabled is able to operate in a normal state.

In some preferred embodiments, the vehicle-mounted wireless communication device, in the case where a predetermined operation is accepted when the prime mover of the vehicle is not turned off, disables some functions of the communicator that is inside the vehicle or reception of signals from the communicator that is inside the vehicle. The vehicle thereby does not operate with the disabled communicator, even in the case where the prime mover is running.

According to some preferred embodiments, the vehicle-mounted wireless communication device, in the case where the locking instruction receiving means receives a signal relating to a door locking instruction and the communicators are detected by the detecting means as being outside the vehicle and inside the vehicle, temporarily suspends some functions of the communicator that is inside the vehicle, thus making it possible to improve convenience of use, since the doors can be locked, even in the case where two communicators are utilized, and even if a spare communicator is hidden inside the vehicle or is given to a passenger for safekeeping as a countermeasure to the communicator being lost.

Also, after locking the doors of the vehicle, the vehicle does not operate with the disabled communicator. Accordingly, even if a suspicious person breaks into the vehicle, that person cannot start the prime mover using the spare communicator that is kept inside the vehicle. It is thereby possible to prevent security from being compromised.

### BRIEF DESCRIPTION OF DRAWINGS

FIG. 1 is a block diagram showing the configuration of a vehicle-mounted wireless communication device according to a preferred embodiment.

FIG. 2 is a block diagram showing the configuration of a wireless key.

FIG. 3 is a flowchart showing the procedure of disabling-related control processing performed when locking doors utilizing a main key.

FIG. 4 is a flowchart showing the procedure of enabling-related control processing performed when unlocking doors utilizing a main key.

FIG. 5 is a flowchart showing the procedure of enabling-related control processing performed when starting an engine utilizing a main key.

### DESCRIPTION

### Embodiment 1

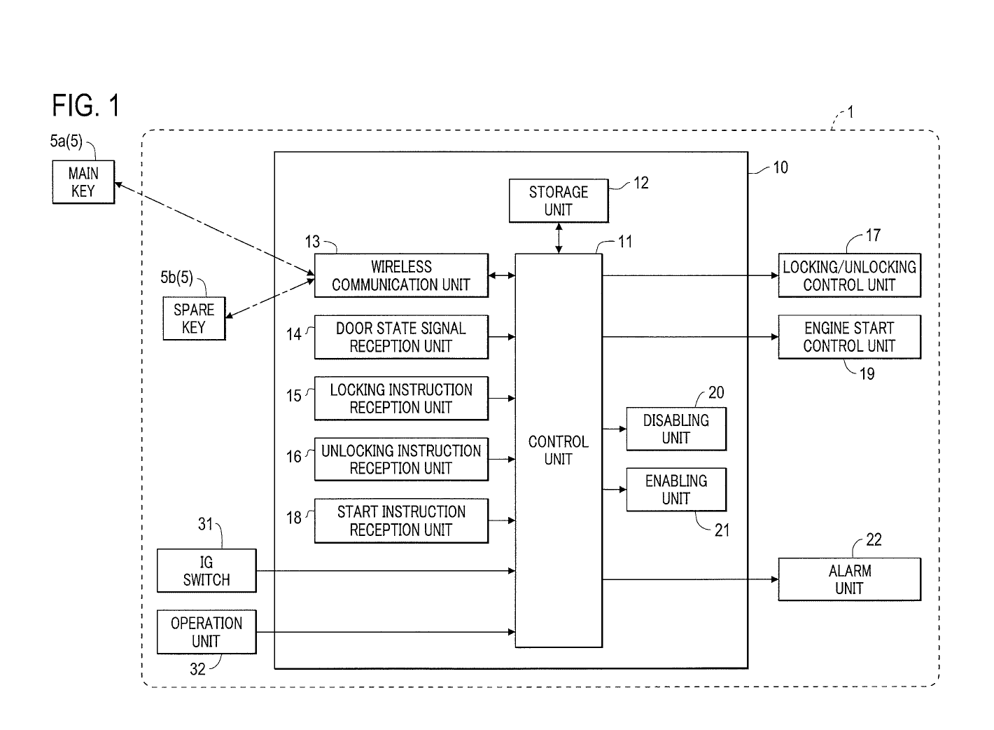

Hereinafter, a preferred embodiment will be specifically described based on drawings showing embodiments thereof. FIG. 1 is a block diagram showing the configuration of a vehicle-mounted wireless communication device according to a preferred embodiment. Reference sign 1 indicated with a dashed line in FIG. 1 denotes a vehicle, and the vehicle 1 has installed therein a vehicle-mounted wireless communication device 10 that performs wireless communication with a portable wireless key 5 which is possessed by a user, and instructs locking/unlocking of the doors of the vehicle 1, starting of an engine which serves as a prime mover, and the like. Also, the vehicle-mounted wireless communication device 10 is provided with a function of disabling/enabling some functions of the wireless key 5 that is inside the vehicle 1. Note that, in the present embodiment, the wireless key 5 includes a main key 5a and a spare key 5b.

Signals indicating ON and OFF from an ignition switch (IG switch) 31 of the vehicle 1 and signals indicating a locked state from an operation unit 32 for locking/unlocking and provided in each door of the vehicle 1 are input to the vehicle-mounted wireless communication device 10, and processing for locking/unlocking the doors, instructing to start the engine, and disabling/enabling the wireless key 5 that is inside the vehicle is performed based on these signals. The IG switch 31 is configured to output binary signals, and outputs a signal indicating an ON state when the engine of the vehicle 1 is operating, and outputs a signal indicating an OFF state when the engine of the vehicle 1 is not operating. The operation unit 32 is an interior operation unit that is provided on the inside of each door of the vehicle 1 for a user to lock/unlock the door, and respectively outputs binary signals indicating the locked/unlocked state of each door, irrespective of whether or not the user is in possession of the wireless key 5.

The vehicle-mounted wireless communication device 10 is provided with a control unit 11, a storage unit 12, a wireless communication unit 13, a door state signal reception unit 14, a locking instruction reception unit 15, an unlocking instruction reception unit 16, a start instruction reception unit 18, a disabling unit 20, an enabling unit 21, and the like. The control unit 11 is specifically constituted by a processing unit such as a CPU (Central Processing Unit) or an MPU (Micro-Processing Unit), and performs processing for controlling the operations of each of the units within the vehicle-mounted wireless communication device 10, various types of computational processing, and the like, by reading out and executing programs and data stored in advance in the storage unit 12. Also, the control unit 11 is connected to a locking/unlocking control unit 17, an engine start control unit 19, an alarm unit 22 and the like, and transmits control signals to the locking/unlocking control unit 17, the engine start control unit 19, the alarm unit 22 and the like.

The storage unit 12 stores data produced following processing by the control unit 11 together with programs, data and the like required in operations by the control unit 11 that are stored in advance. The storage unit 12 may be constituted by a rewritable nonvolatile memory element such as an EEPROM (Electrically Erasable Programmable Read Only Memory) or a flash memory, or may be constituted to separately include a (electrically) non-rewritable nonvolatile memory element such as a mask ROM or an EPROM (Erasable Programmable Read Only Memory) and a volatile memory element such as an SRAM (Static Random Access Memory) or a DRAM (Dynamic Random Access Memory). The storage unit 12 stores authentication information required for authentication processing performed with the wireless key 5, such as an ID of the wireless key 5, for example. Also, the storage unit 12 stores disabling information relating to the wireless key 5 having been disabled by the disabling unit 20 which will be discussed later.

The wireless communication unit 13 communicates wirelessly with the wireless key 5. Although not illustrated, the vehicle 1 is provided with both an in-vehicle antenna and an external antenna. The wireless communication unit 13 is configured to transmit a wireless signal via the in-vehicle antenna or the external antenna under the control of the control unit 11, and to receive a wireless signal that is transmitted from the wireless key 5 in response to the transmitted wireless signal with the in-vehicle antenna or the external antenna and provide data that is included in the received wireless signal to the control unit 11. The control unit 11 is able to detect whether the wireless key 5 is inside the vehicle 1 or outside the vehicle 1, depending on which of the antennas receives the wireless signal from the wireless key 5. Different frequency bands may be utilized for wireless transmission from the wireless communication unit 13 to the wireless key 5 and for wireless transmission from the wireless key 5 to the wireless communication unit 13.

Also, the wireless signals transmitted to and from the wireless communication unit 13 and the wireless key 5 include identification information such as an encrypted ID and information for decryption. The control unit 11 performs authentication processing for determining whether the ID of the wireless key 5 obtained through wireless communication with the wireless communication unit 13 matches an ID stored in advance in the storage unit 12, and control processing for locking/unlocking the doors, starting the engine, and the like if the authentication processing is successful.

The door state signal reception unit 14 is configured to input the output signal of a sensor, a switch or the like (illustration is omitted) provided in each of a plurality of doors of the vehicle 1, and detects whether each door is in an open state or a closed state and provides the detection result to the control unit 11.

The locking instruction reception unit 15 and the unlocking instruction reception unit 16 are respectively connected to a locking switch and an unlocking switch (not shown) for instructing locking and unlocking of the doors. The locking switch and the unlocking switch are, for example, provided in a door handle on the outside of the vehicle 1. In the case where the locking switch is operated, the locking instruction reception unit 15 receives a signal relating to a door locking instruction from the locking switch. In the case where the unlocking switch is operated, the unlocking instruction reception unit 16 receives a signal relating to a door unlocking instruction from the unlocking switch.

The vehicle-mounted wireless communication device 10 is configured to communicate with the wireless key 5, in the case where the locking instruction reception unit 15 or the unlocking instruction reception unit 16 has received a signal. If communication is established between the vehicle-mounted wireless communication device 10 and the wireless key 5 and authentication is successful, the control unit 11 transmits a control signal instructing execution of locking/unlocking control to the locking/unlocking control unit 17. The locking/unlocking control unit 17 controls locking/unlocking of each of the doors of the vehicle 1, in response to the instruction from the control unit 11. Each door of the vehicle 1 is provided with a mechanical mechanism relating to locking/unlocking and a locking mechanism (illustration is omitted) having an actuator or the like that operates the mechanical mechanism, and the locking/unlocking control unit 17 separately outputs a control signal instructing locking/unlocking to each locking mechanism.

The start instruction reception unit 18 is connected to the starting switch (not shown) for instructing to start the engine. The starting switch is, for example, provided in an instrument panel of the vehicle 1. If the starting switch is operated, the start instruction reception unit 18 receives a signal relating to an engine start instruction from the starting switch. The vehicle-mounted wireless communication device 10 is configured to communicate with the wireless key 5, in the case where the start instruction reception unit 18 has received a signal. If communication is established between the vehicle-mounted wireless communication device 10 and the wireless key 5 and authentication is successful, the control unit 11 transmits a control signal instructing execution of control to start the engine to the engine start control unit 19. The engine start control unit 19 provides an instruction to start the engine to a control device (illustration is omitted) of the engine installed in the vehicle 1, in response to the instruction from the control unit 11. Here, authentication for starting the engine has a higher authentication level than the authentication level for locking/unlocking the doors. The authentication for starting the engine is, for example, so-called immobilizer authentication.

The disabling unit 20 executes disabling processing in response to control by the control unit 11. For example, the disabling unit 20 is able to disable some functions of the wireless key 5 that is inside the vehicle 1, by transmitting a wireless signal including a sleep command to that wireless key 5 with the wireless communication unit 13 and transitioning the wireless key 5 to a sleep state. Also, the disabling unit 20 may be configured to disable reception of the wireless signal from the wireless key 5, by rejecting a response signal of the wireless key 5, based on the ID of the wireless key 5 that is inside the vehicle 1 received by the wireless communication unit 13. Here, the functions of the wireless key 5 that are disabled are, for example, functions relating to authentication or functions relating to locking/unlocking the doors and functions relating to starting the engine.

The enabling unit 21 executes enabling processing in response to control by the control unit 11. For example, the enabling unit 21 is able to restore the functions of the wireless key 5 that were disabled by the disabling unit 20 and enable the wireless key 5, by transmitting a wireless signal including a sleep cancel command to the wireless key 5 that is inside the vehicle 1 using the wireless communication unit 13 and transitioning the wireless key 5 from the sleep state to a normal state. Also, the enabling unit 21 may be configured to enable reception of the signal from the wireless key 5, by cancelling rejection of the response signal of the wireless key 5, based on the ID of the wireless key 5 that is inside the vehicle 1 received by the wireless communication unit 13.

The alarm unit 22 emits an alarm to outside the vehicle 1, by outputting an alarm sound with a buzzer, speaker or the like, in response to a control signal from the control unit 11. Also, the alarm produced by the alarm unit 22 is not limited to sound output, and configurations may be adopted in which an alarm is produced by causing a warning lamp to turn on or flash, in which an alarm is produced by causing headlights or the like of the vehicle 1 to turn on or flash, and in which a warning message is displayed on a liquid crystal display or the like provided in the vehicle 1, among other configurations.

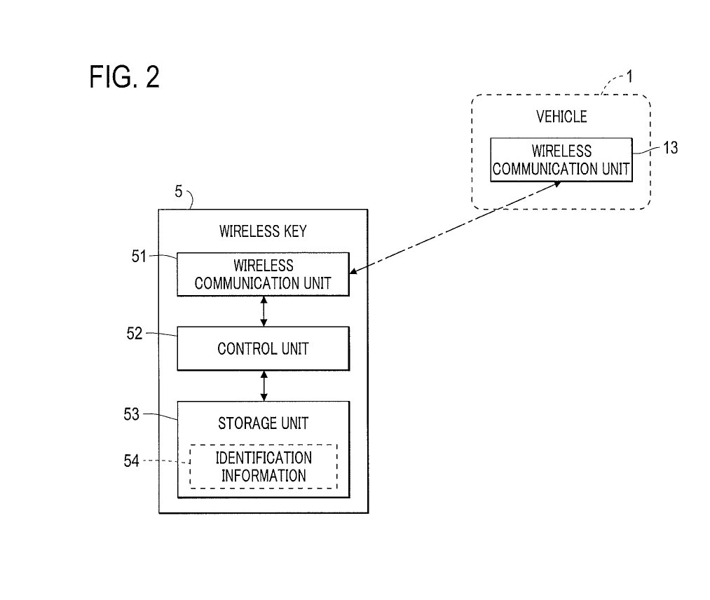

FIG. 2 is a block diagram showing the configuration of the wireless key 5. Note that since the configurations of the main key 5a and the spare key 5b are substantially the same, these configurations are collectively illustrated as “wireless key 5” in FIG. 2. The wireless key 5 is a portable key such as card type or a key holder type key, and is provided with a wireless communication unit 51, a control unit 52, a storage unit 53 and the like. The wireless communication unit 51 communicates wirelessly with the wireless communication unit 13 of the vehicle-mounted wireless communication device 10 installed in the vehicle 1. The wireless communication unit 51 receives a wireless signal from the vehicle 1 via a built-in antenna (illustration is omitted), and provides data that is included in the received wireless signal to the control unit 52. Also, the wireless communication unit 51 transmits data provided from the control unit 52 to the vehicle 1 as a wireless signal.

The control unit 52 performs processing for controlling the operations of each of the units within the wireless key 5, and various types of computational processing. The control unit 52, in the case where data received from the vehicle 1 is provided from the wireless communication unit 51, determines whether the received data is response request data that includes the ID of the vehicle 1 or command data indicating a sleep/sleep cancel command. If it is determined that the received data is response request data, the control unit 52 determines whether the ID of the vehicle 1 that is included in the data matches the ID of the vehicle 1 stored in advance in the storage unit 53, and responds to the vehicle 1 through wireless communication if the IDs of the vehicle 1 match. When responding to the vehicle 1, the control unit 52 reads out the ID of the wireless key 5 stored in advance in the storage unit 53, and includes the ID in data to be transmitted to the vehicle 1. The vehicle-mounted wireless communication device 10, having received a wireless signal from the wireless key 5, performs authentication processing using the ID that is included in the wireless signal. Also, if it is determined that the received data is command data, the control unit 52 transitions the wireless key 5 to one of the sleep state and the normal state, according to the command data. In the sleep state, at least the transmission function of the wireless key 5 is suspended, thus preventing the wireless key 5 from transmitting a response signal externally.

The storage unit 53 is constituted using a rewritable nonvolatile memory element such as an EEPROM. The storage unit 53 stores the ID of the wireless key 5 and the ID of the vehicle 1 that serves as a communication partner in advance as identification information 54. Note that the main key 5a and the spare key 5b differ only in the respective ID that is stored as the identification information 54, and the remaining configuration is substantially the same.

The control unit 11 of the vehicle-mounted wireless communication device 10, in the case where the locking instruction reception unit 15 has received a signal, communicates outside the vehicle 1 with the main key 5a using the wireless communication unit 13, and if authentication processing based on information received from the main key 5a is successful, determines whether the engine is turned off, based on the signal from the IG switch. If the engine of the vehicle 1 is turned off or if the engine of the vehicle 1 is not turned off and the signal received by the locking instruction reception unit 15 is a predetermined signal, the control unit 11 communicates inside the vehicle 1 with the spare key 5b using the wireless communication unit 13. Here, the predetermined signal is a signal corresponding to a predetermined operation, such as a long press or a double tap of the locking switch, for example. If the spare key 5b is inside the vehicle 1, the control unit 11, for example, disables some functions of the spare key 5b using the disabling unit 20, stores disabling information relating to the spare key 5b having been disabled in the storage unit 12, and instructs the locking/unlocking control unit 17 to lock each door (or all doors). Also, if the engine of the vehicle 1 is not turned off and the signal received by the locking instruction reception unit 15 is not a predetermined signal, the control unit 11 instructs the locking/unlocking control unit 17 to lock each door (or all doors), and does not perform disabling processing using the disabling unit 20.

Also, the control unit 11 of the vehicle-mounted wireless communication device 10, in the case where the unlocking instruction reception unit 16 has received a signal, communicates outside the vehicle 1 with the main key 5a using the wireless communication unit 13, and if authentication processing based on information received from the main key 5a is successful, instructs the locking/unlocking control unit 17 to unlock each door (or all doors). If disabling information is stored in the storage unit 12, the control unit 11, for example, enables the spare key 5b using the enabling unit 21, and deletes the disabling information stored in the storage unit 12.

Similarly, the control unit 11 of the vehicle-mounted wireless communication device 10, in the case where the start instruction reception unit 18 has received a signal, communicates wirelessly with the wireless key 5 and performs authentication processing, and if the authentication processing is successful, instructs the engine start control unit 19 to start the engine. If disabling information is stored in the storage unit 12, the control unit 11, for example, enables the spare key 5b using the enabling unit 21, and deletes the disabling information stored in the storage unit 12.

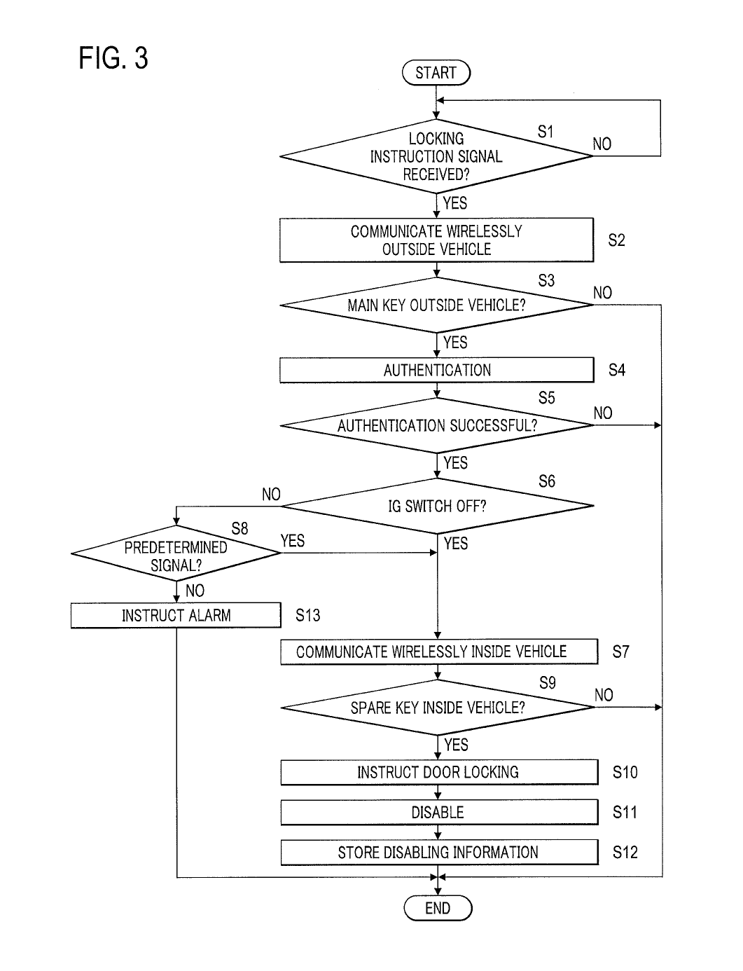

FIG. 3 is a flowchart showing the procedure of disabling-related control processing performed when locking doors utilizing the main key 5a, and is processing that is performed by the control unit 11 of the vehicle-mounted wireless communication device 10. The control unit 11 of the vehicle-mounted wireless communication device 10 starts the processing in the case where it is detected by the door state signal reception unit 14 that all of the doors of the vehicle 1 are in a closed state.

The control unit 11 determines whether the locking instruction reception unit 15 has received a signal relating to a door locking instruction (step S1), and if a signal relating to a door locking instruction has not been received (step S1: NO), stands by until the locking instruction reception unit 15 receives a signal relating to a door locking instruction.

If a signal relating to a door locking instruction has been received (step S1: YES), the control unit 11 communicates wirelessly outside the vehicle 1 with the main key 5a using the wireless communication unit 13 (step S2). The control unit 11 determines whether the main key 5a is outside the vehicle 1, according to the wireless signal received by the wireless communication unit 13 (step S3).

If the main key 5a is outside the vehicle 1 (step S3: YES), the control unit 11 performs authentication processing based on authentication information acquired through wireless communication with the main key 5a (step S4), and determines whether the authentication processing was successful (step S5). If the authentication processing was successful (step S5: YES), the control unit 11 determines whether the IG switch 31 of the vehicle 1 is in an OFF state (step S6).

If the IG switch 31 is in an OFF state (S6: YES), the control unit 11 communicates wirelessly inside the vehicle 1 with the spare key 5b using the wireless communication unit 13 (step S7). If the IG switch 31 is in an ON state (step S6: NO), the control unit 11 determines whether the signal received by the locking instruction reception unit 15 is a predetermined signal (step S8). In the case of a predetermined signal (step S8: YES), the control unit 11 transitions processing to step S7.

Next, the control unit 11 determines whether the spare key 5b is inside the vehicle 1, according to the wireless signal received by the wireless communication unit 13 (step S9), and if the spare key 5b is inside the vehicle 1 (step S9: YES), transmits a control signal instructing to execute locking control to the locking/unlocking control unit 17 (step S10), and transmits a control signal to the disabling unit 20 such that the disabling unit 20 disables some functions of the spare key 5b (step S11). Next, the control unit 11 stores disabling information relating to the spare key 5b having been disabled in the storage unit 12 (step S12), and ends the processing.

If the signal received by the locking instruction reception unit 15 is not a predetermined signal (step S8: NO), the control unit 11 transmits a control signal instructing execution of an alarm to the alarm unit 22 (step S13), and ends the processing. The control unit 11 thus ends the processing.

Also, if the main key 5a is not outside the vehicle 1 (step S3: NO), if the authentication processing is not successful (step S5: NO), or if the spare key 5b is not inside the vehicle 1 (step S9: NO), the control unit 11 ends the processing.

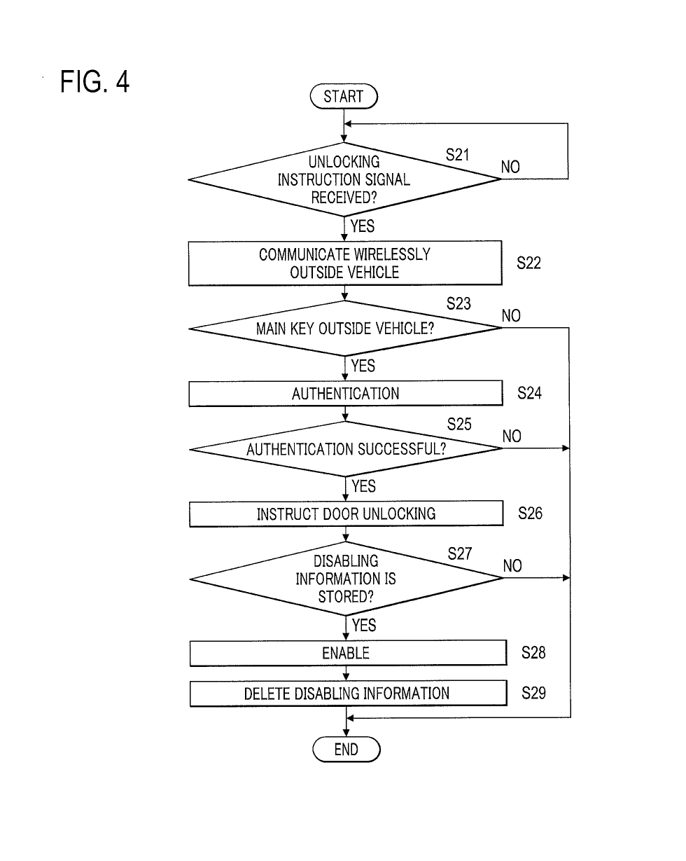

FIG. 4 is a flowchart showing the procedure of enabling-related control processing performed when unlocking doors utilizing the main key 5a, and is processing that is performed by the control unit 11 of the vehicle-mounted wireless communication device 10, The control unit 11 starts the processing in the case where the doors of the vehicle 1 are locked.

The control unit 11 determines whether the unlocking instruction reception unit 16 has received a signal relating to a door unlocking instruction (step S21), and if a signal relating to a door unlocking instruction has not been received (step S21: NO), stands by until a signal relating to a door unlocking instruction is received.

If a signal relating to a door unlocking instruction has been received (step S21: YES), the control unit 11 communicates wirelessly outside the vehicle 1 with the main key 5 a using the wireless communication unit 13 (step S22). The control unit 11 determines whether the main key 5a is outside the vehicle 1, according to the wireless signal received by the wireless communication unit 13 (step S23).

If the main key 5a is outside the vehicle 1 (step S23: YES), the control unit 11 performs authentication processing based on authentication information acquired through wireless communication with the main key 5a (step S24), and determines whether the authentication processing was successful (step S25). If the authentication processing was successful (step S25: YES), the control unit 11 transmits a control signal to the locking/unlocking control unit 17 instructing execution of unlocking control (step S26).

Next, the control unit 11 determines whether disabling information is stored in the storage unit 12 (step S27). If disabling information is stored in the storage unit 12 (step S27: YES), the control unit 11 transmits a control signal to the enabling unit 21 such that the enabling unit 21 enables the disabled spare key 5b based on the disabling information (step S28), and the control unit 11 then deletes the disabling information stored in the storage unit 12 (step S29), and ends the processing.

If the main key 5a is not outside the vehicle 1 (step S23: NO), if the authentication processing was not successful (step S25: NO), or if disabling information is not stored in the storage unit 12 (step S27: NO), the control unit 11 ends the processing.

### Embodiment 2

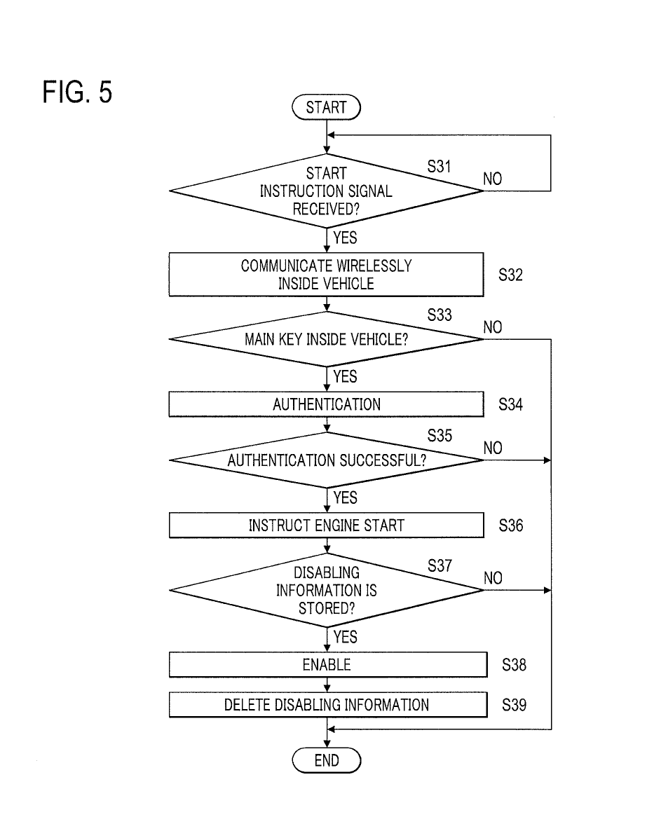

Embodiment 1 described an example of enabling the disabled spare key 5b when unlocking doors, whereas Embodiment 2 describes an example of enabling the disabled spare key 5b when starting the engine. FIG. 5 is a flowchart showing the procedure of enabling-related control processing performed when starting the engine using the main key 5a, and is processing that is performed by the control unit 11 of the vehicle-mounted wireless communication device 10. The control unit 11 starts the processing in the case where the IG switch 31 of the vehicle 1 is in an OFF state.

The control unit 11 determines whether the start instruction reception unit 18 has received a signal relating to an engine start instruction (step S31), and if a signal relating to an engine start instruction has not been received (step S31: NO), stands by until a signal relating to an engine start instruction is received.

If a signal relating to an engine start instruction has been received (step S31: YES), the control unit 11 communicates wirelessly inside the vehicle 1 with the main key 5a using the wireless communication unit 13 (step S32). The control unit 11 determines whether the main key 5 a is inside the vehicle 1, according to the wireless signal received by the wireless communication unit 13 (step S33).

If the main key 5a is inside the vehicle 1 (step S33: YES), the control unit 11 performs authentication processing based on authentication information acquired through wireless communication with the main key 5a (step S34), and determines whether the authentication processing was successful (step S35). If the authentication processing was successful (step S35: YES), the control unit 11 transmits a control signal instructing execution of engine start control to the engine start control unit 19 (step S36).

Next, the control unit 11 determines whether disabling information is stored in the storage unit 12 (step S37). If disabling information is stored in the storage unit 12 (step S37: YES), the control unit 11 transmits a control signal to the enabling unit 21 such that the enabling unit 21 enables the disabled spare key 5b based on the disabling information (step S38), and the control unit 11 then deletes the disabling information stored in the storage unit 12 (step S39), and ends the processing.

If the main key 5a is not inside the vehicle 1 (step S33: NO), if the authentication processing is not successful (step S35: NO), or if disabling information is not stored in the storage unit 12 (step S37: NO), the control unit 11 ends the processing.

With the vehicle-mounted wireless communication device 10 having the above configuration, the doors can be locked utilizing the main key 5a and the spare key 5b, even in the case where the spare key 5b is kept into the vehicle 1, by temporarily suspending some functions of the spare key 5b that is inside the vehicle 1 in a state where the doors of the vehicle 1 are locked, thus making it possible to improve convenience of use.

Also, after the doors have been locked, the vehicle 1 cannot be operated with the spare key 5b that is inside the vehicle 1, and thus even if a suspicious person breaks into the vehicle 1, the engine cannot be started using the spare key 5b that is kept inside the vehicle 1. Security can thus be secured.

Moreover, by enabling the disabled spare key 5b when the engine is started, security can be further secured.

In the above-mentioned embodiments, the case where the wireless key 5 includes the main key 5a and the spare key 5b was described, but a configuration may be adopted in which a plurality of wireless keys 5 belong to the vehicle 1, and the user keeps one of the wireless keys 5 inside the vehicle 1 as the spare key 5b. For example, a configuration can be adopted in which the wireless key 5 that was last used to lock the doors of the vehicle 1 is treated as the main key 5a, and the other wireless key 5 is treated as the spare key 5b. In this case, the control unit 11, when locking the doors in response to wireless communication with a wireless key 5, stores the ID of the wireless key 5 that was used, and thereafter the processing shown in FIGS. 3 to 5 may be performed with the wireless key 5 having the stored ID as the main key 5a.

In the above-mentioned embodiments, signals that are received by the locking instruction reception unit 15 and the unlocking instruction reception unit 16 were described taking signals corresponding to operations performed on the locking switch and the unlocking switch as an example, but preferred embodiments are not limited thereto, and may be applied in relation to signals corresponding to keyless locking/unlocking operations.

In the above-mentioned embodiments, the locking instruction reception unit 15, the unlocking instruction reception unit 16, and the start instruction reception unit 18 are provided separately, but may be commonly provided.

Also, in the above-mentioned embodiments, an example was described in which the prime mover of the vehicle 1 is an engine, but the prime mover of the vehicle 1 may be a motor. In this case, control for starting the motor can be performed instead of control for starting an engine.

Also, in the above-mentioned embodiments, disabling processing and enabling processing were described taking processing for disabling some functions of the spare key 5b and processing for enabling the functions of the spare key 5b that were disabled as an example, but preferred embodiments are not limited thereto, and may be applied in relation to processing for disabling reception of signals from the spare key 5b and processing for enabling reception of signals from the spare key 5b that was disabled.

Also, in the above-mentioned procedure shown in the flowchart of FIG. 3, a configuration was adopted in which steps S10 to S12 were performed sequentially. However, preferred embodiments are not limited thereto, and a configuration may be adopted in which these steps are performed in order of disabling processing (step S11), processing for storing disabling information (step S12), and processing for instructing execution of locking control (step S10).

The presently disclosed embodiments are considered in all respects to be illustrative and not restrictive. The scope of the invention is indicated by the appended claims rather than the foregoing description, and all changes that come within the meaning and range of equivalence thereof are intended to be embraced therein.

### Reference Signs List

1 Vehicle

10 Vehicle-mounted wireless communication device

11 Control unit (detecting means, determining means)

12 Storage unit

13 Wireless communication unit (wireless communicating means)

14 Door state signal reception unit

15 Locking instruction reception unit (locking instruction receiving means)

16 Unlocking instruction reception unit (unlocking instruction receiving means)

17 Locking/unlocking control unit

18 Start instruction reception unit (start instruction receiving means)

19 Engine start control unit

20 Disabling unit (disabling means)

21 Enabling unit (enabling means)

22 Alarm unit

5 Wireless key (communicator)

5a Main key (communicator)

5b Spare key (communicator)

51 Wireless communication unit

52 Control unit

53 Storage unit

1. A wireless communication device configured to be mounted in a vehicle, the wireleless communication device comprising:
a wireless transceiver configured to transmit and receive wireless signals to and from a plurality of portable communicators;
a detector configured to determine which of the plurality of communicators are outside the vehicle and which of the plurality of communicators are inside the vehicle, according to the wireless signals transmitted and received by the wireless transceiver;
a locking instruction receiver configured to receive a signal relating to a door locking instruction; and
a communicator disabling device configured to disable some functions of communicators determined to be inside the vehicle when the locking instruction receiver receives the signal relating to the door locking instruction, and communicators are determined to be outside the vehicle and inside the vehicle at the same time.

2. The wireless communication device according to claim 1, comprising:
a start instruction receiver configured to receive a signal relating to a prime mover start instruction; and
a communicator enabling device configured to enable functions of communicators determined to be inside the vehicle when the start instruction receiver receives the signal relating to the prime mover start instruction.

3. The wireless communication device according to claim 1, comprising:
an unlocking instruction receiver configured to receive a signal relating to a door unlocking instruction; and
a communicator enabling device configured to enable functions of communicators that were disabled by the communicator disabling device when the unlocking instruction receiver receives the signal relating to the door unlocking instruction.

4. The wireless communication device according to claim 1, comprising:
a determinator configured to determine whether a signal received by the locking instruction receiver is a predetermined signal,
wherein the communicator disabling device is configured to disable some functions of communicators determined to be inside the vehicle when it is determined by the determinator that the signal received by the locking instruction receiver is the predetermined signal.

5. A wireless communication device configured to be mounted in a vehicle, the wireless communication device comprising:
a wireless transceiver configured to transmit and receive wireless signals to and from a plurality of portable communicators;
a detector configured to determine which of the plurality of communicators are outside the vehicle and which of the plurality of communicators are inside the vehicle, according to the wireless signals transmitted and received by the wireless transceiver;
a locking instruction receiver configured to receive a signal relating to a door locking instruction; and
a communicator disabling device configured to disable reception of wireless signals from communicators determined to be inside the vehicle when the locking instruction receiver receives the signal relating to the door locking instruction, and communicators are determined to be outside the vehicle and inside the vehicle at the same time.

6. The wireless communication device according to claim 5, comprising:
start instruction receiver configured to receive a signal relating to a prime mover start instruction; and
a communicator enabling device configured to enable reception of wireless signals from communicators disabled by the communicator disabling device when the start instruction receiver receives the signal relating to the prime mover start instruction.

7. The wireless communication device according to claim 5, comprising:
an unlocking instruction receiver configured to receive a signal relating to a door unlocking instruction; and
a communication enabling device configured to enable reception of wireless signals from communicators that were disabled by the communicator disabling device when the unlocking instruction receiver receives the signal relating to the door unlocking instruction.

8. The wireless communication device according to claim 5, comprising:
a determinator configured to determine whether a signal received by the locking instruction receiver is a predetermined signal,
wherein the communicator disabling device is configured to disable reception of wireless signals from communicators determined to be inside the vehicle when it is determined by the determinator that the signal received by the locking instruction receiver is the predetermined signal.
